(19) United States
(12) Patent Application Publication
(10) Pub. No.: US 2007/0196633 A1
(43) Pub. Date: Aug. 23, 2007

(54) DURABLE TRANSPARENT COATINGS FOR POLYMERIC SUBSTRATES

(76) Inventors: Craig E. Coak, Kenmore, WA (US); Vasan S. Sundaram, Issaquah, WA (US); Warren W. Wascher, Belen, NM (US)

Correspondence Address: KLEIN, O'NEILL & SINGH, LLP, 43 CORPORATE PARK, SUITE 204, IRVINE, CA, 92606, US

(21) Appl. No.: 11/696,661

(22) Filed: Apr. 4, 2007

Related U.S. Application Data
(63) Continuation-in-part of application No. 11/289,920, filed on Nov. 30, 2005.

(51) Int. Cl. B32B 7/02; B05D 7/00; B32B 9/04

(52) U.S. Cl. 428/215; 427/407.1; 428/409; 428/216; 428/332; 428/447; 428/448

(57) ABSTRACT

Duplex coating schemes and associated methods of formation, including a siloxane-based soft coating and a plasma-based SiOₓC_{y} hard coating used in combination to improve the durability of polymeric substrates.

### CROSS-REFERENCE TO RELATED APPLICATIONS

This application is continuation-in-part of application Ser. No. 11/289,920, filed on Nov. 30, 2005, the entire contents of which are hereby incorporated by reference.

### BACKGROUND OF THE INVENTION

1. Field of the Invention

The present invention relates to transparent protective coatings for polymeric substrates, such as windows and shields for view screens.

2. Background

Polymers have a wide range of applications as transparent components. For example, many eyeglass lenses are constructed of polycarbonate, which is preferred to glass because of its lighter weight and greater ability to refract light. Aircraft passenger windows are typically made of stretched acrylic due to its light weight, flexibility and formability. Many electronic handheld devices, such as cellular phones, portable music players and personal data assistants, include view screens that are protected behind transparent shields. These shields can be made of polycarbonate, acrylic, resin-based plastics, etc.

Unfortunately, many transparent polymers do not have adequate resistance to wear and erosion from, for example, particulate matter (e.g. sand), water, chemicals and contact with other solid objects. These polymers would quickly develop scratches and crazing if subjected to the conditions to which eyeglasses, windows and handheld devices are typically subjected. For example, FIG. 1 illustrates an example of a substrate 10 that has suffered extensive scratches and crazing 12. Therefore, to increase the wear resistance of these polymers they are typically coated with harder transparent substances.

Presently, acrylic and other types of aircraft windows are protected by sol-gel based polysiloxane coatings. The sol-gel coatings are homogeneous mixtures of a solvent, an organosilane, alkoxide and a catalyst that are processed to form a suitable coating. The sol-gel coatings provide high transmittance, but limited durability against wear and UV induced degradation. Moreover, during flight, aircraft windows are subjected to differential pressures caused by the difference in pressure between the inside and the outside of the aircraft. The combination of cabin differential pressure and aerodynamic stresses during flight causes the windows to flex, and therefore can cause most sol-gel coatings to crack, subsequently allowing chemicals to attack the acrylic substrate and in some cases allowing the coating to delaminate from the acrylic substrate.

### SUMMARY OF THE INVENTION

The preferred embodiments of the present durable transparent coatings for polymeric substrates have several features, no single one of which is solely responsible for their desirable attributes. Without limiting the scope of these coatings as expressed by the claims that follow, their more prominent features will now be discussed briefly. After considering this discussion, and particularly after reading the section entitled “Detailed Description of the Preferred Embodiments”, one will understand how the features of the preferred embodiments provide advantages, which include increased durability while preserving the ability of the substrate to flex.

One aspect of the present coatings includes the realization that there is a need for transparent, hard coatings that improve the durability and extend the lifetime of polymeric substrates. Of even greater advantage would be coatings that were resilient against chemicals and showed strong weatherability characteristics.

One embodiment of the present coatings comprises a duplex coating for a polymeric substrate. The coating is configured to enhance the durability of the substrate. The coating comprises a first, relatively soft, polysiloxane-based coating covering at least a portion of a first surface of the substrate, and a second, relatively hard, silicon-based coating covering at least a portion of the first coating. The first coating has a thickness of between about 0.1 and 10 microns, a hardness of between about 100 MPa and 500 MPa, and a modulus of between about 1 GPa and 9 GPa. The second coating has a thickness of between about 0.1 and 10 microns, a hardness of between about 100 MPa and 4 GPa, and a modulus of between about 8 GPa and 20 GPa.

Another embodiment of the present coatings comprises a method of forming a duplex coating on a substrate. The coating is configured to enhance the durability of the substrate. The method comprises depositing a first, relatively soft, polysiloxane-based coating on at least a portion of a first surface of the substrate, and depositing a second, relatively hard, silicon-based coating on at least a portion of the first coating. The first coating has a thickness of between about 0.1 and 10 microns, a hardness of between about 100 MPa and 500 MPa, and a modulus of between about 1 GPa and 9 GPa. The second coating has a thickness of between about 0.1 and 10 microns, a hardness of between about 100 MPa and 4 GPa, and a modulus of between about 8 GPa and 20 GPa.

The present duplex coatings advantageously improve weatherability, resistance to chemical exposure, wear resistance and resistance to flexing-induced crazing of substrates. In addition, the optical properties (light transmittance in the visible region of the solar spectrum, clarity and haze) of substrates with the duplex coatings are about the same as those of a substrate having a single polysiloxane coating.

### BRIEF DESCRIPTION OF THE DRAWINGS

The preferred embodiments of the present durable transparent coatings for polymeric substrates will now be discussed in detail with an emphasis on highlighting the advantageous features. These embodiments depict the novel and non-obvious coatings shown in the accompanying drawings, which are for illustrative purposes only. These drawings include the following figures, in which like numerals indicate like parts:

FIG. 1 is a front elevation view of a substrate exhibiting extensive scratches and crazing;

FIG. 2 is a schematic cross-sectional view of a substrate with a duplex coating in accordance with one embodiment of the present coatings;

FIG. 3 is a graph illustrating Taber wear test results for stretched acrylic with polysiloxane and one embodiment of the present duplex coatings;

FIG. 4 is a schematic cross-sectional view of a three point flex test on a coated substrate;

FIG. 5 is a simplified schematic of a cyclic load/temperature profile used to test one embodiment of the present duplex coatings;

FIG. 6 is a graph showing changes in dry adhesion index of a polysiloxane coated stretched acrylic and one embodiment of the present duplex coated stretched acrylics as a result of exposure to various chemicals for 24 hours;

FIG. 7 is a graph showing changes in wet adhesion index of a polysiloxane coated stretched acrylic and one embodiment of the present duplex coated stretched acrylics as a result of exposure to various chemicals for 24 hours; and

FIG. 8 is a graph showing Taber wear test results of a polysiloxane coated stretched acrylic and one embodiment of the present duplex coated stretched acrylics after chemical exposure.

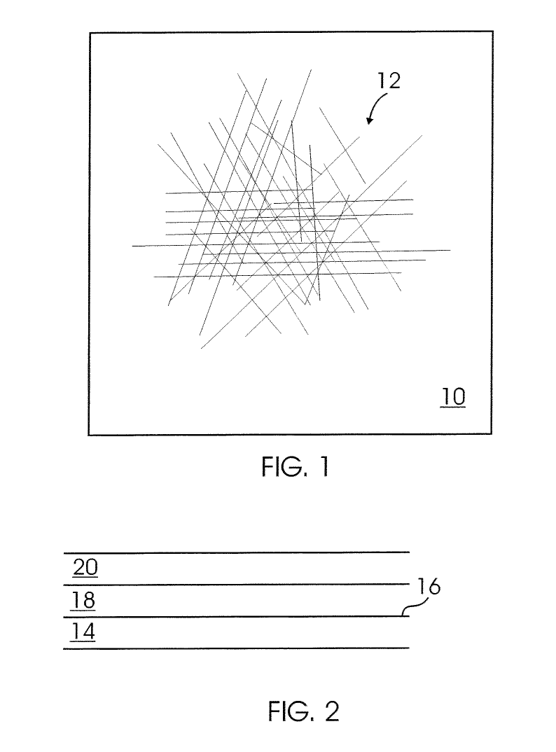

### DETAILED DESCRIPTION OF THE PREFERRED EMBODIMENTS

FIG. 2 illustrates schematically one embodiment of the present duplex coating for substrates. The substrate 14 may be any polymer, such as polycarbonate, acrylic, stretched acrylic or a resin-based structural plastic. The substrate 14 may have any configuration, such as flat or concave/convex, and may be adapted for use in virtually any application. For example, the substrate 14 may be a thin flat sheet adapted to be used as a protective shield over a view screen on a handheld electronic device, such as a cell phone or a personal data assistant. Alternatively, the substrate 14 may be a relatively thick flat sheet adapted to be used as a window in a passenger aircraft. Those of ordinary skill in the art will appreciate that the range of applications for the present duplex-coated substrates is endless. Additional examples of substrates that could include the present duplex-coatings include, without limitation, monitor screens (such as for computers and televisions) and protective shields for such screens, windows, windshields and sun/moonroofs for all types of land- and water-based vehicles, including cars, trucks, railcars and boats, protective shields over light sources, such as vehicle headlights/taillights and flashlights, protective shields over digital displays on electronic devices, such as alarm clocks, microwaves, ovens, digital cameras, etc.

A first surface 16 of the substrate 14 includes a first coating 18, or “soft” coating 18, and a second coating 20, or “hard” coating 20, overlying the first coating 18. In one embodiment the soft coating 18 may be an adherent polysiloxane-based layer, and the hard coating 20 may be a silicon-based layer. Silicon-based materials are advantageously harder and more durable than polysiloxane-based materials. Unfortunately, however, silicon-based materials typically do not bond well to polymeric substrates. Thus, one advantage of the soft coating 18 is that it provides a bonding layer for the hard coating 20. The soft coating 18 is applied to the substrate 14 prior to the hard coating 20, and the hard coating 20 bonds chemically to the soft coating 18 layer and provides a hard outer surface.

The soft coating 18 need not be very thick to provide sufficient adhesion for the hard coating 20. For example, in one embodiment, the soft coating 18 may be between about 100 and 200 Angstroms thick. In accordance with one advantage of the present coatings, however, the soft coating 18 acts not only as an adhesion enhancing layer, but also as a load bearing and flexibility enhancing layer. To enhance the flexibility and load bearing characteristics of the soft coating 18, its hardness and modulus may be tuned. In one embodiment the soft coating 18 may have a hardness between about 100 MPa and 500 MPa, and a modulus between about 1 GPa and 9 GPa. An embodiment of the soft coating 18 having a hardness of about 300 MPa and a modulus of about 5 GPa has demonstrated advantageous properties of flexibility and load bearing capacity.

To further enhance the flexibility and load bearing characteristics of the soft coating 18 it may be made thicker. In certain embodiments the soft coating 18 may be between about 0.1 and 10 microns thick. The thickness of the soft coating 18 will be influenced by the anticipated application for the substrate 14. For example, in applications where the substrate 14 needs to exhibit a greater amount of flexibility, the soft coating 18 may be relatively more thick, such as between about 4 and 5 microns. In other applications where the substrate 14 needs to exhibit a lesser amount flexibility, the soft coating 18 may be relatively more thin, such as between about 2 and 4 microns.

In one embodiment the hard coating 20 may be a silicon-based layer, such as for example a SiOₓC_{y}-based layer, with x ranging from 1.0 to 1.2, and y ranging from 1.0 to 0.8. Alternatively, the hard coating 20 may be a DIAMONDSHIELD® layer available from Morgan Advanced Ceramics of Allentown, Pa. or a transparent DYLAN™ coating available from Bekaert Advanced Coating Technologies of Amherst, N.Y. In one embodiment, the hard coating 20 is deposited onto the substrate 14 using plasma techniques, such as ion beam-assisted plasma vapor deposition or plasma-enhanced chemical vapor deposition. For example, several materials deposited using plasma techniques are disclosed in “Comparison of silicon dioxide layers grown from three polymethylsiloxane precursors in a high-density oxygen plasma” by Y. Qi, et al., Journal of Vacuum Science & Technology, A 21(4), July/August 2003, the entire contents of which are incorporated herein by reference.

The silicon-based coating is a relatively hard coating 20 that provides better wear resistance, chemical inertness and other durability properties as compared to other coatings generated by wet chemical methods such as sol-gel coatings. Further, the ion bombardment effects that occur during plasma deposition of silicon-based transparent coatings improve the hardness and durability of the coatings. The ion bombardment enhances the surface mobility of the depositing species and improves the optical quality (haze and clarity) of the coating. To enhance the durability of the hard coating 20, its hardness and modulus may be tuned. In one embodiment the hard coating 20 may have a hardness between about 100 MPa and 4 GPa, and a modulus between about 8 GPa and 20 GPa. An embodiment of the hard coating 20 having a hardness of about 2 GPa and a modulus of about 14 GPa has demonstrated advantageous durability.

To further enhance the durability of the hard coating 20 its thickness may be tuned. In certain embodiments the hard coating 20 may be between about 0.1 and 10 microns thick. The thickness of the hard coating 20 will be influenced by the anticipated application for the substrate 14. For example, in applications where the substrate 14 needs to exhibit a greater amount of flexibility, the hard coating 20 may be relatively more thin, such as between about 4 and 5 microns. In other applications where the substrate 14 needs to exhibit a lesser amount flexibility, the soft coating 18 may be relatively more thick, such as between about 5 and 8 microns.

The tuned hardnesses, moduli and thicknesses of the present duplex coatings advantageously enhance the durability of the substrates to which they are applied. Further, for flexible substrates the present duplex coatings enhance durability while also preserving the flexibility of the substrates. This flexibility preservation is of particular advantage when compared to prior art silicon-dioxide coatings, which have high hardness and high modulus. For example, for certain applications requiring a flexible substrate a duplex coating according to the present embodiments may be applied as follows. The soft coating 18 may have a relatively low hardness and modulus and relatively large thickness. The hard coating 20 may have a relatively low hardness, moderate modulus and be relatively thin. Such a duplex coating preserves the flexibility of the substrate 14 as compared to a silicon-dioxide coating because the soft coating 18 is able to bear some of the load as the substrate 14 flexes, and the hard coating 20 does not severely restrict the flexing of the substrate 14 and the soft coating 18. The hardness of the duplex coating, however, reduces flexing-induced crazing that is typical of substrates coated with only polysiloxane.

Referring again to FIG. 2, in one example embodiment the substrate 14 is first treated and coated with the soft coating 18. The soft coating 18 may be a 4 to 5 micron thick polysiloxane-based, adherent, transparent coating. Next, the silicon-based transparent hard coating 20 is deposited on the soft coating 18 using an ion assisted plasma process. The hard coating 20 may be a 4 to 5 micron thick layer of DIAMONDSHIELD®. The deposition process may include at least one silicon-containing precursor, such as hexamethydisiloxane, and oxygen. The plasma deposition conditions, such as gas flow, deposition pressure, plasma power and the like, may be adjusted to produce hard, transparent coatings in accordance with well known plasma deposition principles.

In one embodiment the substrate 14 and/or the soft coating 18 may be chemically cleaned to remove contaminants, such as hydrocarbons, prior to loading the substrate 14 into a vacuum chamber for the application of the hard coating 20. The cleaning process may include, for example, ultrasonic cleaning in solvents and/or aqueous detergents. Once the desired vacuum conditions are obtained, the substrate 14 may be sputter cleaned using inert ions and/or oxygen ions. After the cleaning step is complete, the hard coat may then be applied.

Coating Performance Evaluation:

A series of comparisons have been made to validate the improved performance of the present duplex coating versus a polysiloxane coating on acrylic substrates. The results of these comparisons are outlined below. Nothing in these comparisons should be interpreted as limiting the scope of the present embodiments.

To perform the comparisons, a first group (Group I) of stretched acrylic substrates was coated with a polysiloxane coating to a thickness of about 4 microns. A second group (Group II) of stretched acrylic substrates was first coated with a polysiloxane coating to a thickness of about 4 microns, followed by a plasma-based hard coating to a thickness of about 5 microns.

Wear Test:

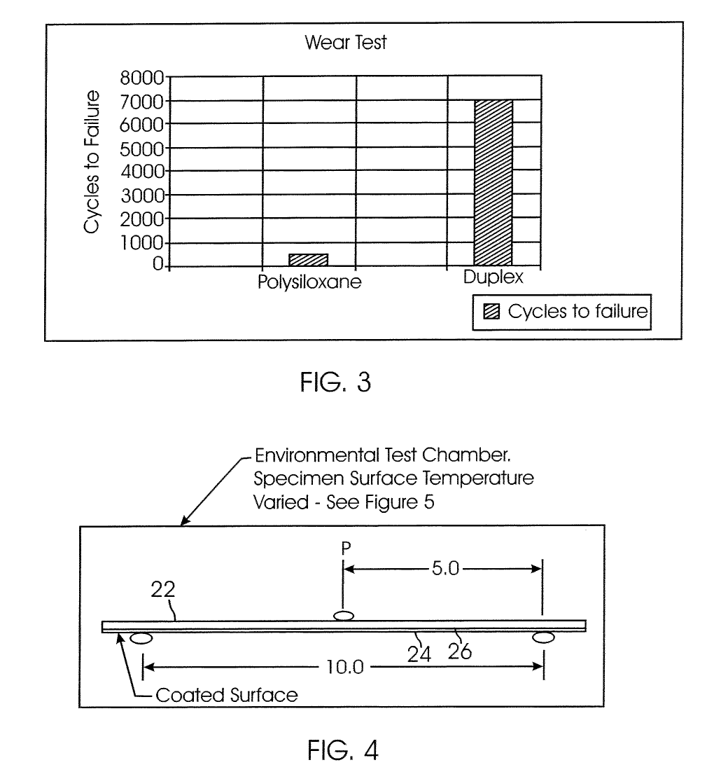

The coated substrates (Group I & Group II) were tested for wear in accordance with the procedure described in ASTM D-1044-99, “Standard Test Method for Resistance of Transparent Plastics to Surface Abrasion”. This test includes two CS-10F wheels with a load of 500 gm applied to each. The wheels abrade the coated acrylic substrate surfaces as they rotate. The increase in haze was used as the criteria for measuring the severity of abrasion. The tests were run until the haze increased by 5% as a result of the abrasion. The results of tests are shown in FIG. 3, which illustrates that the present duplex coatings exhibit improved wear resistance by more than an order of magnitude when compared to the polysiloxane coating.

Flex Test:

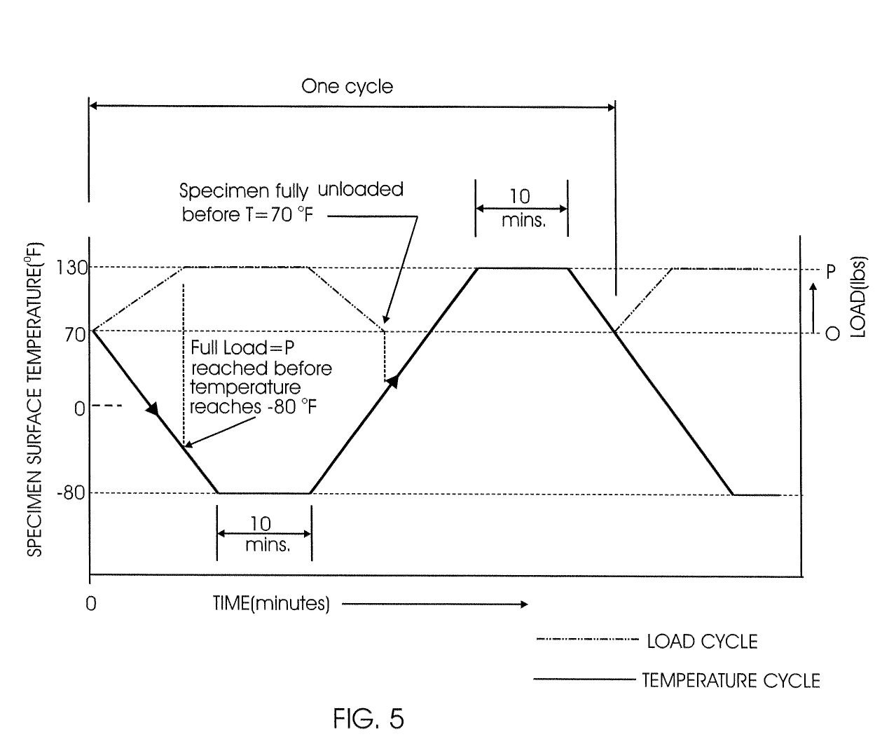

A modified ASTM D-790 test protocol was used to conduct the flex tests of the coated components. Samples 22 of dimensions 1″×12″×0.5″ with coatings 24 (Group I & II) were subjected to a three point bend test as shown in FIG. 4. The surface 26 of the sample 22 having the coating 24 is facing down in this figure. A thin film of 75 wt % sulfuric acid in water was applied to the coating using a fiberglass filter and a TEFLON® tape. The test article was subjected to a cyclic load/temperature profile as shown in FIG. 5. An ultimate load of 3600 psi was used in these tests. The tests were continued until the coating cracked or the surface exhibited crazing (whichever occurred first). The results show that while the polysiloxane coated substrates (Group I) failed in 50 cycles, the present duplex coated substrates (Group II) showed no cracking or crazing even after 500 cycles.

Chemical Exposure Test:

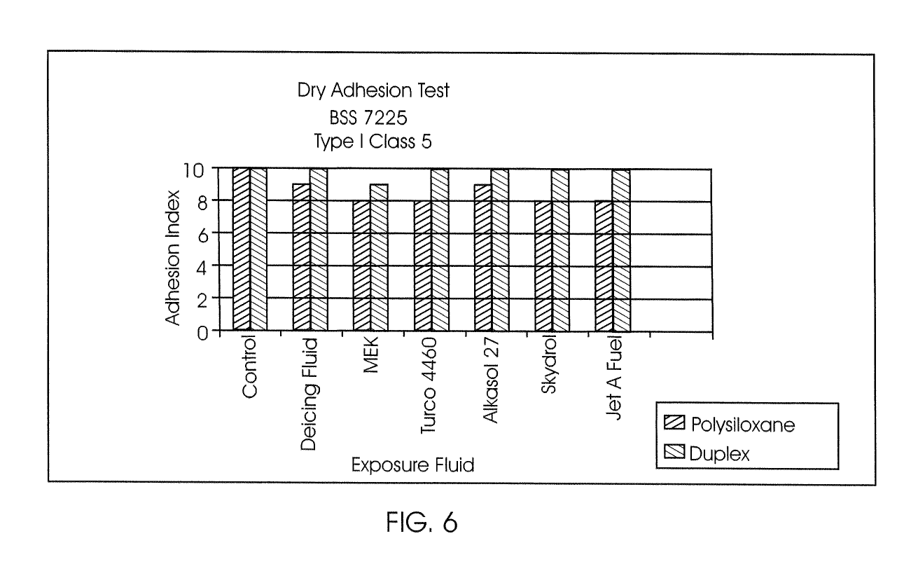

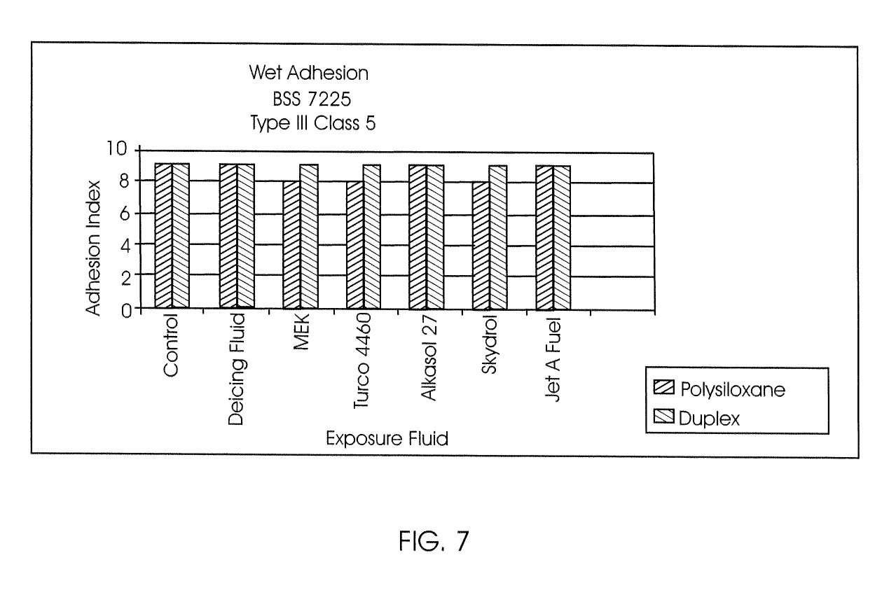

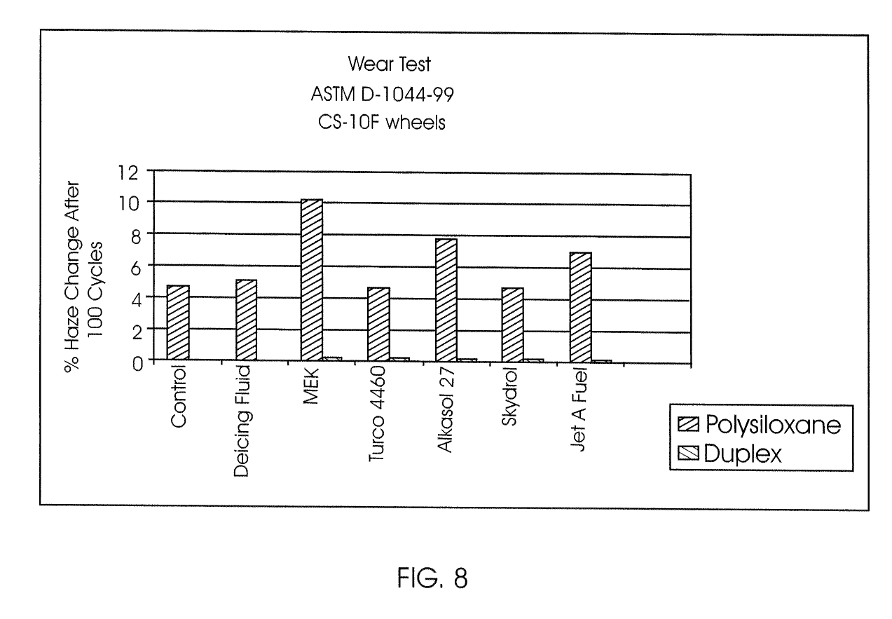

Stretched acrylic substrates with the present duplex coating were exposed to chemicals that are normally used in the performance of aircraft maintenance. The samples were exposed to each chemical for a period of 24 hours (exception: exposure to MEK was for 4 hours) and then tested for adhesion (modified ASTM D 3330-BSS 7225) and % haze change due to wear when tested per ASTM D-1044-99. The results are shown in FIGS. 6, 7 and 8 for the polysiloxane coated substrates (Group I) and the duplex coated substrates (Group II). The samples with duplex coatings exhibited no degradation in adhesion (as indicated by adhesion index) or wear induced haze change as a result of chemical exposure.

UV/Humidity Exposure:

The coated (Group I & Group II) substrates were exposed to ultraviolet light (UV-A lamp with peak wavelength at 340 nm) and humidity for a total exposure of 300 KJ/m² in accordance with SAE J1960. The exposure consisted of 40 minutes of light, 20 minutes of light with front spray, 60 minutes of light and 60 minutes of dark with front and back spray. Another set of samples from Groups I & II were first exposed to various chemicals (per the chemical test above) and then subjected to the UV/Humidity test protocol. In both of these tests, the samples with the duplex coating showed no degradation as a result of UV/humidity exposure and performed better than those with single polysiloxane coating alone.

The above description presents the best mode contemplated for carrying out the present durable transparent coatings for polymeric substrates, and of the manner and process of making and using them, in such full, clear, concise, and exact terms as to enable any person skilled in the art to which they pertain to make and use these coatings. These coatings are, however, susceptible to modifications and alternate constructions from those discussed above that are fully equivalent. Consequently, these coatings are not limited to the particular embodiments disclosed. On the contrary, these coatings cover all modifications and alternate constructions coming within the spirit and scope of the coatings as generally expressed by the following claims, which particularly point out and distinctly claim the subject matter of the coatings.

What is claimed is:

1. A duplex coating for a polymeric substrate, the coating being configured to enhance the durability of the substrate, comprising:
a first, relatively soft, polysiloxane-based coating covering at least a portion of a first surface of the substrate; and
a second, relatively hard, silicon-based coating covering at least a portion of the first coating;
wherein the first coating has a thickness of between about 0.1 and 10 microns, a hardness of between about 100 MPa and 500 MPa, and a modulus of between about 1 GPa and 9 GPa; and
the second coating has a thickness of between about 0.1 and 10 microns, a hardness of between about 100 MPa and 4 GPa, and a modulus of between about 8 GPa and 20 GPa.

2. The duplex coating of claim 1, wherein the first coating has a thickness of between about 2 and 8 microns, a hardness of between about 200 MPa and 400 MPa, and a modulus of between about 3 GPa and 7 GPa, and the second coating has a thickness of between about 2 and 8 microns, a hardness of between about 1 GPa and 3 GPa, and a modulus of between about 11 GPa and 17 GPa.

3. The duplex coating of claim 1, wherein the first coating has a thickness of between about 3 and 5 microns, a hardness of about 300 MPa, and a modulus of about 5 GPa, and the second coating has a thickness of between about 4 and 6 microns, a hardness of about 2 GPa, and a modulus of about 14 GPa.

4. The duplex coating of claim 1, wherein the substrate is constructed of at least one material selected from the group consisting of: polycarbonate, acrylic, stretched acrylic and resin-based structural plastics.

5. The duplex coating of claim 1, wherein the second coating comprises a SiOₓC_{y}-based material, with x ranging from 1.0 to 1.2, and y ranging from 1.0 to 0.8.

6. The duplex coating of claim 1, wherein the second coating is deposited on the first coating using a plasma-based technique.

7. A method of forming a duplex coating on a substrate, the coating being configured to enhance the durability of the substrate, the method comprising:
depositing a first, relatively soft, polysiloxane-based coating on at least a portion of a first surface of the substrate; and
depositing a second, relatively hard, silicon-based coating on at least a portion of the first coating;
wherein the first coating has a thickness of between about 0.1 and 10 microns, a hardness of between about 100 MPa and 500 MPa, and a modulus of between about 1 GPa and 9 GPa; and
the second coating has a thickness of between about 0.1 and 10 microns, a hardness of between about 100 MPa and 4 GPa, and a modulus of between about 8 GPa and 20 GPa.

8. The method of claim 7, wherein the first coating has a thickness of between about 2 and 8 microns, a hardness of between about 200 MPa and 400 MPa, and a modulus of between about 3 GPa and 7 GPa, and the second coating has a thickness of between about 2 and 8 microns, a hardness of between about 1 GPa and 3 GPa, and a modulus of between about 11 GPa and 17 GPa.

9. The method of claim 7, wherein the first coating has a thickness of between about 3 and 5 microns, a hardness of about 300 MPa, and a modulus of about 5 GPa, and the second coating has a thickness of between about 4 and 6 microns, a hardness of about 2 GPa, and a modulus of about 14 GPa.

10. The method of claim 7, wherein the substrate is constructed of at least one material selected from the group consisting of: polycarbonate, acrylic, stretched acrylic and resin-based structural plastics.

11. The method of claim 7, wherein the second coating comprises a SiOₓC_{y}-based material, with x ranging from 1.0 to 1.2, and y ranging from 1.0 to 0.8.

12. The method of claim 7, wherein the step of depositing the second coating comprises a plasma-based technique.

13. The method of claim 7, further comprising cleaning the first coating and the substrate to remove contaminants prior to performing the step of depositing the second coating.

14. The method of claim 13, wherein the cleaning step comprises ultrasonic cleaning in solvents and/or aqueous detergents.

15. The method of claim 13 wherein the cleaning step comprises sputter cleaning in a vacuum environment using inert ions and/or oxygen ions.
